(19) United States
(12) Patent Application Publication
(10) Pub. No.: US 2023/0173502 A1
(43) Pub. Date: Jun. 8, 2023

(54) A GRINDING MILL ROTOR

(71) Applicant: VECTIS PTY LTD AS TRUSTEE FOR JJB TRUST, Subiaco (AU)

(72) Inventor: Jeffrey Victor Belke, Mount Pleasant (AU)

(73) Assignee: VECTIS PTY LTD AS TRUSTEE FOR JJB TRUST, Subiaco (AU)

(21) Appl. No.: 17/919,292

(22) PCT Filed: Apr. 20, 2021
(86) PCT No.: PCT/AU2021/050350

§ 371 Date: Oct. 17, 2022

(30) Foreign Application Priority Data
Apr. 30, 2020 (AU) 2020901365

(51) Int. Cl. B02C 17/16

(52) U.S. Cl. CPC B02C 17/163

(57) ABSTRACT

There is disclosed a grinding mill rotor for a grinding mill to stir a slurry of mineral ore particles, or other particulate material, and a grinding medium within the grinding mill thereby to cause turbulence within the slurry to promote attrition of the particulate material through interaction with the grinding medium. The grinding mill rotor includes a planar body having an axis of rotation around which the body rotates during use. Several spaced apart paddles are provided on and extend transversely across the body. At least some of the paddles have a rotationally leading face that is angled relative to an orthogonal line extending orthogonally from the axis of rotation of the body, wherein an offset angle β between the leading face and the orthogonal line is selected to be between 1° and 35° to control a rate at which the slurry slides across the planar body during use.

### TECHNICAL FIELD

The present disclosure relates to a grinding mill rotor.

More particularly, the present disclosure relates to a grinding mill rotor for a grinding mill used to grind mineral ore particles or other particulate material, which are typically mixed with a grinding medium and water to form a slurry.

### BACKGROUND

A grinding mill is an apparatus used to pulverise or comminute particulate material. There are a large variety of grinding mills with each being aimed at grinding different types of materials and being configured to yield resultant particles having a desired particulate size. One type of grinding mill, such as the commercially known IsaMill, is a fine grinding mill which is configured for grinding ore particles that are in the range of about 30 µm to 4000 µm in diameter and grinding these down to a target product size having particles with a diameter ranging from about 5 µm to 60 µm.

The fine grinding mill uses inert grinding media, such as silica sand, waste smelter slag or ceramic balls, which is mixed in and stirred together with the ore particles being ground. The fine grinding mill includes a housing defining a grinding chamber in which is provided several grinding mill rotors/stirrers mounted on a rotating shaft. The fine grinding mill may be a vertical shaft mill or horizontal shaft mill. The grinding chamber is filled with a slurry of the grinding medium, the ore particles and water. The grinding mill rotors are configured to cause motion in the slurry resulting in collisions between the ore particles and the grinding medium and between the ore particles and other ore particles, thereby breaking down the ore particles by attrition and abrasion.

US 5,797,550 discloses a fine grinding mill having flat disc-shaped grinding mill rotors. The discs have slots therethrough to allow the slurry to pass through the grinding chamber from a feed end of the housing to its discharge end. As the discs rotate, friction between the disc surface and the slurry sets the slurry in motion and centrifugal forces cause the slurry to flow from the shaft towards the housing. The motion is most pronounced in the boundary layer of the slurry close to the discs with the slurry circulating back from the housing towards the shaft in the zone centrally between neighbouring discs. One drawback that has been found using such flat disc-shaped grinding mill rotors is that there is a relatively large amount of frictional wearing on the rotors as the abrasive slurry flows across the disc surface, particularly when grinding high-density slurries.

As disclosed in PCT/FI2016/050545, one method of overcoming the above-described wearing is to provide a plurality of spaced apart protective elements on the discs to deflect the slurry away from the disc surface. The protective elements extend outwardly in a plane orthogonal to an axis of rotation of the disc and are configured, in use, to define rotating pockets in which slurry is “captured”. The orthogonally directed extension of the protective elements is intended to minimize slippage of the slurry across the disc surface and this is intended to reduce the wear on the grinding discs because the slurry is “moved away” from the grinding discs, i.e. seemingly the “captured” slurry itself forms a protective almost stationary boundary layer between the surface of the grinding discs and the “moving/agitated” slurry. In some embodiments the outer edge of the protective elements terminates flush with the circumferential edge of the discs, whereas in other embodiments the outer edge of the protective elements extends beyond the circumferential edge of the discs. An example of such a disc is shown in FIG. 1a. Due to some of the slurry being “captured”, there is the potential for reduced efficiency of the grinding mill as this “captured” slurry decreases the effective volume of the grinding chamber and thus the operational production rate that can be achieved. It has also been found that, in use, the outer edges of the protective elements, and particularly their leading corners, experience significant wearing due to the high friction caused by movement of the orthogonally extending protective elements through the slurry. An example of this wearing is shown in FIG. 1b, which was found to occur after only a few hours of use (wear on both sides of the protective element occurred because the direction of rotation was reversed). The wearing can lead to contamination of the slurry / ore particles and a loss of efficiency in the grinding process.

The above references to the background art and any prior art citations do not constitute an admission that the art forms part of the common general knowledge of a person of ordinary skill in the art.

### SUMMARY OF THE DISCLOSURE

According to a first aspect of the disclosure, there is provided a grinding mill rotor for a grinding mill, wherein the grinding mill rotor is configured to stir a slurry including particulate material and a grinding medium within the grinding mill thereby to cause turbulence within the slurry to promote attrition of the particulate material through interaction with the grinding medium, the grinding mill rotor comprising
a planar body having an axis of rotation around which the body is configured to rotate during use;
a plurality of paddles provided on the body and extending transversely across the body, the paddles being spaced apart from each other around the axis of rotation, at least some of the paddles having a rotationally leading face that is angled relative to an orthogonal line extending orthogonally from the axis of rotation of the body;
wherein an offset angle β between the leading face and the orthogonal line is selected to be between 1° and 35°, and wherein the offset angle β is selected to control a rate at which the slurry slides across the planar body during use.

The paddles may be substantially block-like having a rectangular cross-section, a triangular cross-section, a V-shaped cross-section, or an arcuate segment shaped cross-section. The body may have opposed surfaces being substantially parallel to each other with the paddles extending from at least one of the opposed surfaces. The body may have an outer radial edge with the paddles extending radially outwardly beyond the outer edge.

The rotor may include a number of arcuate passages extending through the body, whereby an outer portion of the body forms a ring and an inner portion of the body forms spokes leading from the ring towards the axis of rotation. In one embodiment at least one paddle extends across each of the spokes. The rotor may further include one or more slots extending through the outer portion of the body, wherein each slot leads into one of the passages.

A distal edge of the paddles may be orientated substantially tangential to the axis of rotation of the body.

The offset angle β for each paddle may be between 10° to 20°. In one embodiment the offset angle β for each paddle is about 15°.

The offset angle β may be selected to regulate a rate at which the planar body and the paddles experience frictional wear when the slurry is outwardly deflected. Alternatively, the offset angle β may be selected to regulate the grinding efficiency of the grinding mill.

Each paddle may have a curved profile, being curved radially away from or towards an operational direction of rotation of the body, whereby the offset angle β varies along the length of the paddle with a smaller offset angle β¹ nearer to the axis of rotation and with a larger offset angle β² further away from the axis of rotation. In one embodiment the smaller offset angle β¹ is between 5° to 25° and the larger offset angle is between 30° to 40°.

The paddles may be associated into groups within which each paddle that rotationally follows another extends further outwardly than its preceding paddle. In some embodiments the body may enlarge spirally so that all the paddles overhang the body to a similar extent.

The paddles may be integrally formed with the body. Alternatively, the paddles may be rubber polymer or polyurethane structures that are bonded to the body.

A second aspect of the disclosure provides a grinding mill comprising a rotor of the first aspect.

A third aspect of the disclosure provides for the use of the rotor of the first aspect in a grinding mill.

### BRIEF DESCRIPTION OF DRAWINGS

The above and other features will become more apparent from the following description with reference to the accompanying schematic drawings. In the drawings, which are given for purpose of illustration only and are not intended to be in any way limiting:

FIG. 1a is a side view of a prior art grinding mill rotor;

FIG. 1b is a side view photograph of a prior art grinding mill rotor as shown in FIG. 1a showing frictional wearing (rounding) of the outer ends of its protective elements;

FIG. 2 is a perspective view of a first embodiment of a grinding mill rotor according to the present disclosure;

FIG. 3 is a side view of the grinding mill rotor shown in FIG. 2;

FIG. 4 is a perspective view of a second embodiment of a grinding mill rotor according to the present disclosure;

FIG. 5 is a side view of the grinding mill rotor shown in FIG. 4;

FIG. 6 is a side view of a third embodiment of a grinding mill rotor according to the present disclosure;

FIG. 7 is a side view of a fourth embodiment of a grinding mill rotor according to the present disclosure;

FIG. 8 is a side view of a fifth embodiment of a grinding mill rotor according to the present disclosure; and

FIG. 9 is a perspective view of the first embodiment of a grinding mill rotor as shown in FIGS. 2 to 5, but having alternatively shaped paddles.

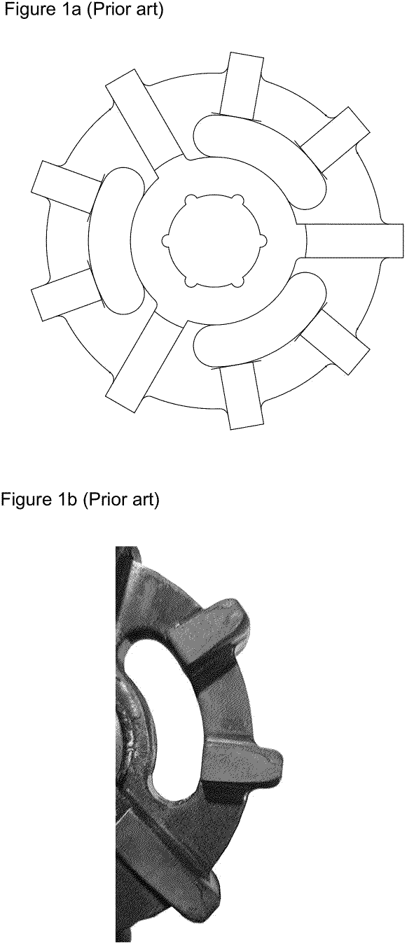

### DETAILED DESCRIPTION

In FIGS. 2 to 8 there are shown various embodiments of a grinding mill rotor of the present disclosure for use in a grinding mill for grinding mineral ore particles or other particulate material, which are typically mixed with a grinding medium and a liquid, e.g. water, to form a slurry. The grinding mill rotors are configured to stir the slurry of the particulate material and the grinding medium within the grinding mill thereby to cause turbulence within the slurry to promote attrition of the particulate ore material through interaction with the grinding medium.

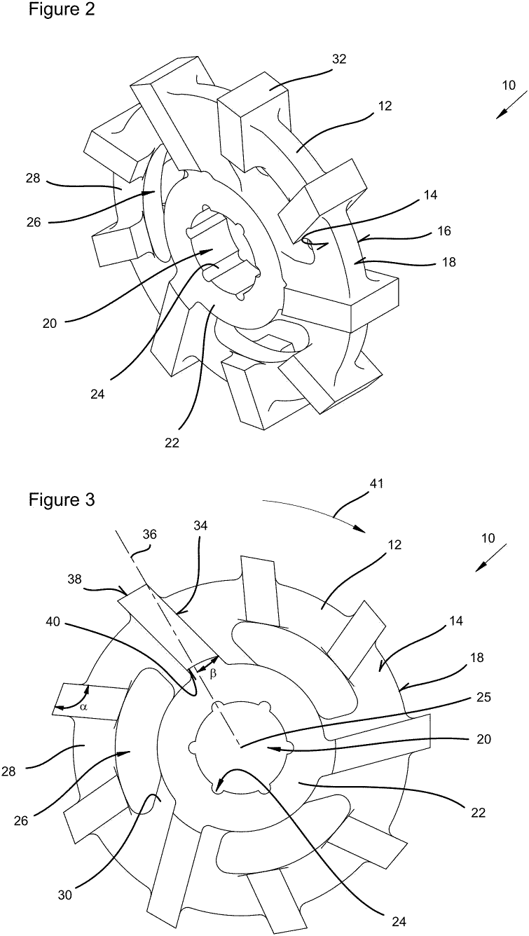

Referring to FIGS. 2 and 3, there is shown a first embodiment of a grinding mill rotor 10 comprising a substantially planar body 12 having opposed planar surfaces 14,16 and an outer edge 18. The exemplary embodiment of the grinding mill rotor 10 is an annular disc, however, it should be understood that the body 12 can also be provided in other regular or irregular polygonal shapes, e.g. being hexagonal or nonagonal in shape. Typically, the internal structure of the body 12 is made of metal or a metal alloy, such as steel.

A central hole 20 extends through the body 12, which hole 20 is surrounded by a mounting collar 22 permitting the grinding mill rotor 10 to be joined to a shaft (not shown). The collar 22 stands proud of the surfaces 14,16 of the body 12. The exemplary embodiment shows several spaced apart elongated grooves 24 formed in an internal circumferential wall of the collar 22 surrounding the hole 20. The grooves 24 are orientated parallel to an axis of rotation 25 of the grinding mill rotor 10 and are configured to engage with complementary tines provided on the shaft. In other embodiments the body 12 can be provided with slots that are configured to cooperate with complementary slots on the shaft so that a removable key can be inserted into the slots for joining the body 12 to the shaft.

The grinding mill rotor 10 further comprises several passages 26 extending through the body 12. In use, the passages 26 are configured to allow the flow of the slurry through the body 12. In the exemplary embodiment there are three discrete passages 26 that are arcuate in shape, e.g. kidney shaped, and that are equally spaced around a major part of the collar 22. This has the effect of causing an outer portion of the body 12 to be in the form of a ring 28 that concentrically surrounds the collar 22 and with a remaining inner portion of the body 12 forming spokes 30 joining the ring 28 to the collar 22.

Several radially spaced apart vanes or paddles 32 are provided on the body 12 and extend laterally outwardly from either one or both of the surfaces 14,16. In the example shown in FIGS. 2 to 5, all the paddles 32 are substantially block-like in appearance having a rectangular cross-section. In the exemplary embodiment of the grinding mill rotor 10 there are nine paddles 32 being equidistantly radially spaced apart at about 40° intervals, with the paddles 32 protruding laterally from the body 12 at right angles from the surfaces 14,16.

In other embodiments at least some or all of the paddles 32 may have other geometric cross-sections, e.g. arcuate segment-shaped, V-shaped, or triangular cross-sections - an example of a rotor 10 showing some of the paddles 32 having such various alternative cross-sections is shown in FIG. 9. In the examples shown in FIG. 9, their rotationally leading faces 34 will laterally intersect the surfaces 14,16 at angle θ. In one example the paddles 32 can protrude at an angle from the body 12 so that one or more of their leading faces 34 are at angle θ of between 90°-120° relative to the surfaces 14,16. In one example at least some of the leading faces 34 are at an angle θ of about 105° relative to the surfaces 14,16.

In one embodiment the paddles 32 are integrally formed with the body 12. In another embodiment the paddles 32 are separate rubber polymer or polyurethane structures that are subsequently bonded to the body 12.

The paddles 32 extend transversely along the body 12 from the collar 22 towards and beyond the outer edge 18 with at least one of the paddles 32 being aligned with and extending across each of the spokes 30. Any paddles 32 that are aligned with the passages 26 are interrupted so that the paddles 32 do not traverse the passages 26, i.e. so that they do not partially block the passages 26 or restrict flow of the slurry therethrough.

At least some of the paddles 32 are angled rotationally backwardly or forwardly so that their leading faces 34 are offset from an orthogonal line 36 extending orthogonally from the axis of rotation 25 of the grinding mill rotor 10. In the exemplary embodiment, wherein the body 12 is substantially in the shape of a planar disc, the orthogonal line 36 extends radially outwardly from the centre of the body 12. The offset angle β for one of the leading faces 34 is indicated in FIG. 3, with the offset angle being the same for each other paddle 32 in the example shown in FIG. 3. The offset angle β is between 1° to 35°, preferably between 10° to 20°, and in the exemplary embodiment is about 15°. For clarity, having an offset angle β of 0° would result in the leading face 34 lying on (being co-linear with) the orthogonal line 36. It should be appreciated that the maximum offset angle will be dependent on the outer radius of the collar 22 and, at its greatest will be when the leading faces 34 are orientated tangentially to the collar 22. In other examples, each of the paddles 32 can have its own selected offset angle β, e.g. wherein each paddle 32 has a unique offset angle β or wherein one or more of the paddles 32 have the same selected offset angle β.

A distal edge 38 of the paddles 32 is orientated to be substantially tangential to the axis of rotation 25 of the grinding mill rotor 10, while a proximal edge 40 of the paddles 32 is concentric to the collar 22. Due to the angled leading face 34 and the tangential distal edge 38, an internal angle α at the corner between the leading face 34 and the tangential distal edge 38 comprises an obtuse angle, which is about 105° in the exemplary embodiment. As the internal angle α increases, the corner between the leading face 34 and the tangential distal edge 38 becomes less pronounced and thus the paddle 32 becomes less susceptible to frictional wearing. In some embodiments this corner may be chamfered or filleted.

In use, the shaft carrying the grinding mill rotors 10 is rotated about its axis of rotation 25, normally in the direction rotation indicated by arrow 41 but sometimes in a reverse direction, thereby to cause rotation of the grinding mill rotors 10. As will be understood by the skilled addressee, this rotation will stir the slurry of the particulate material and the grinding medium within the grinding mill thereby to cause turbulence within the slurry to promote interaction between the particulate material and the grinding medium within the grinding chamber of the grinding mill to thereby promote attrition of the particulate material. The paddles 32 act to further agitate the slurry and increase mixing of the slurry. Coarse ore particles in the slurry move to the outer side of the mill where they undergo further grinding, while fine or finished ground ore particles flow through the passages 26 towards an exit of the grinding mill to prevent overgrinding of those ore particles. It will be appreciated that some slurry may be partially trapped in zones adjacent the surfaces 14,16 between neighbouring paddles 32 and that this trapped slurry will not be mixed as thoroughly as slurry lying outside these zones. Movement of this trapped slurry will be caused by friction between the surfaces 14,16 and the slurry with centrifugal forces causing the slurry to flow or slide in a radially outward direction from the collar 22 towards the outer edge 18. This outward movement is assisted by the offset angle β so that the paddles 32 outwardly deflect the slurry. The paddles 32 thus have a dual purpose, firstly of assisting with this mixing process by agitating the slurry, and secondly of controlling the rate at which the slurry slides across the surfaces 14,16.

Changing the offset angle β of the paddles 32 allows control of the rate at which the slurry slides across the body 12, i.e. the surfaces 14,16, and whereby having a smaller offset angle β decreases the rate at which the slurry slides across the body 12, while having a larger offset angle β increases the rate at which the slurry slides across the body 12. The wearing of the surfaces 14,16 increases with an increase in the rate at which the slurry slides across the surfaces 14,16.

It will also be appreciated that having a smaller offset angle β results in the paddles 32 experiencing greater friction near their distal edges 38 as the paddles 32 move through the slurry, whereas having a larger offset angle β reduces the friction because the slurry is more easily able to slide past the distal edge 38.

Accordingly, having a smaller offset angle β decreases the wearing on the surfaces 14,16 but increases the wearing on the distal edges 38 of the paddles 32, whereas having a larger offset angle β increases the wearing on the surfaces 14,16 but decreases the wearing on the distal edges 38. Selecting the optimal offset angle β in each case of use will be dependent on the density of the slurry as well as on the rate of rotation of the grinding mill rotors 10 and the specified grinding criteria. In one embodiment the offset angle β is selected to regulate a rate at which the body 12 and the paddles 32 experience frictional wear when the slurry is outwardly deflected, whereas in another embodiment the offset angle β is selected to regulate a grinding efficiency of the grinding mill housing the grinding mill rotor 10.

A comparative energy test of the rotor 10 having its paddles set at offset angle β at 15° versus a prior flat disc rotor (having no paddles) and a prior art disc rotor having orthogonal paddles (i.e. offset angle β = 0°) provided the results shown in Table 1, wherein it can be seen that the rotor 10 yielded energy savings over both prior art rotors:

Table 1

Comparative energy tests

| | Specific Grinding Energy SGE (kW.hr / tonne) | | | % SGE Reduction (15 Degrees vs Flat Disc) | % SGE Reduction (15 Degrees vs Orthogonal) |
|---|---|---|---|---|---|
| P80 (microns) | Flat Disc | Orthogonal Paddle Rotor | 15 Degree Paddle Rotor | | |
| 31 | 14.3 | 12.0 | 10.1 | 29% | 16% |
| 28 | 17.3 | 14.3 | 12.2 | 29% | 15% |
| 20 | 32.3 | 25.4 | 22.3 | 31% | 12% |
| 17 | 43.7 | 33.5 | 29.9 | 32% | 11% |
| 14 | 62.7 | 46.6 | 42.4 | 32% | 9% |
| 12 | 83.6 | 60.5 | 56.0 | 33% | 7% |
| 10 | 117.4 | 82.5 | 77.7 | 34% | 6% |

A further comparative test of the same rotors provided the frictional wearing results shown in Table 2, wherein it can be seen that the rotor 10 yielded lower rates of wearing compared to both prior art rotors:

Table 2

Comparative frictional wearing tests

| | Test Steel Rotor Wear Rate (g / kW.hr) | | | % Wear Rate Reduction (15 Degrees vs Flat Disc) | % Wear Rate Reduction (15 Degrees vs Orthogonal) |
|---|---|---|---|---|---|
| Rotor Position | Flat Disc | Orthogonal Paddle Rotor | 15 Degree Paddle Rotor | | |
| 1 | 3.1 | 1.4 | 1.1 | 64% | 23% |
| 2 | 2.7 | 1.2 | 1.2 | 56% | 4% |
| 3 | 2.7 | 1.3 | 1.1 | 59% | 15% |
| 4 | 2.7 | 1.1 | 0.7 | 74% | 35% |
| 5 | 1.9 | 0.8 | 0.2 | 89% | 76% |
| 6 | 0.3 | 0.1 | 0.0 | 95% | 84% |
| Overall | 13.2 | 5.9 | 4.3 | 68% | 28% |

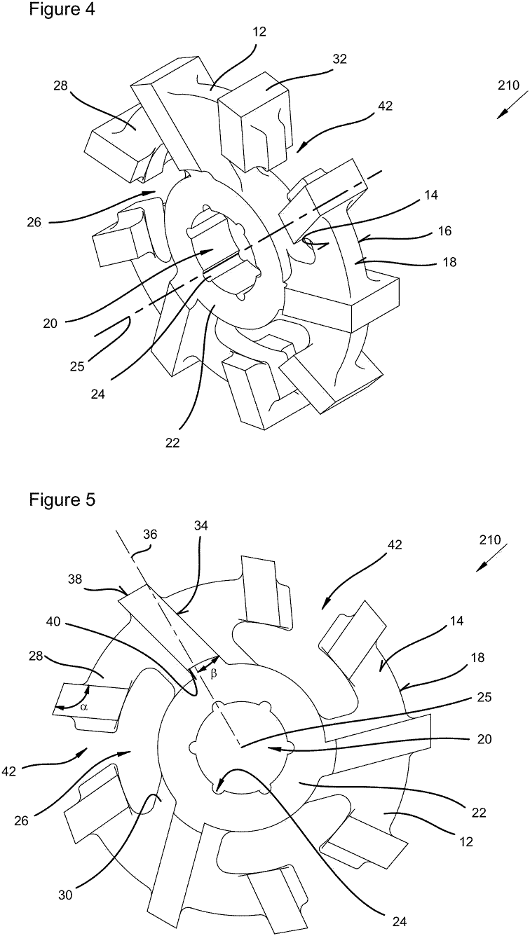

Referring now to FIGS. 4 and 5, there is shown a second embodiment of a grinding mill rotor 210. The grinding mill rotor 210 is largely similar to the grinding mill rotor 10 and thus the same parts are indicated using the same reference numerals. The grinding mill rotor 210 differs from the grinding mill rotor 10 in that the grinding mill rotor 210 has slots 42 extending through the ring 28 of the body 12, wherein each slot 42 extends from the outer edge 18 into one of the passages 26. The slots 42 assist in increasing the rate at which the slurry flows past the grinding mill rotors 210 and thus the rate at which the slurry passes through the grinding mill.

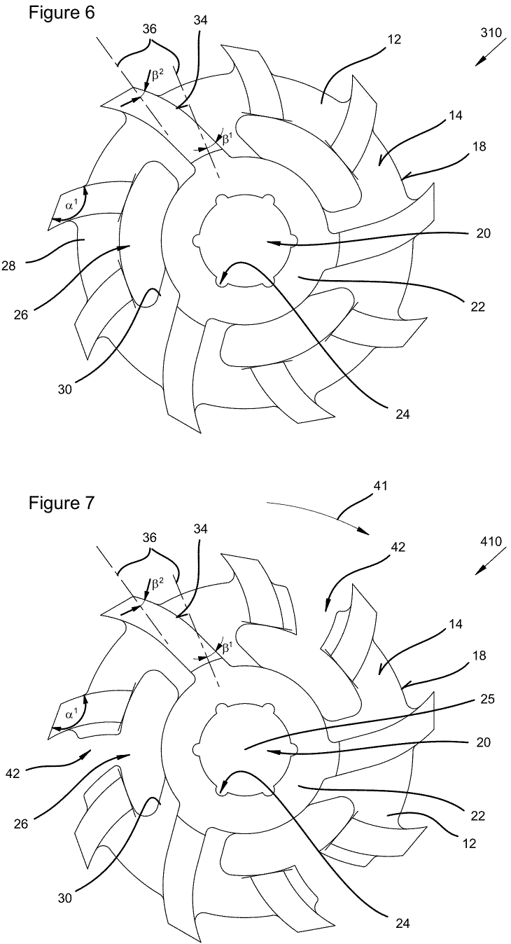

FIG. 6 shows a third embodiment of a grinding mill rotor 310 being similar to the first embodiment grinding mill rotor 10, while FIG. 7 shows a fourth embodiment of a grinding mill rotor 410 being similar to the third embodiment grinding mill rotor 210. In both the grinding mill rotors 310,410 the paddles 32 have a curved profile being curved radially away from the operational direction of rotational, i.e. so that the offset angle β varies along the length of the paddles 32, with a smaller offset angle β¹ nearer to the axis of rotation 25 (i.e. nearer the collar 22) and with a larger offset angle β² further away from the axis of rotation 25 (i.e. nearer the distal edge 38). This curved profile causes the rate at which the slurry slides across the surfaces 14,16 to increase as the slurry moves further away from the axis of rotation 25 of the grinding mill rotor 310,410. The smaller offset angle β¹ is between 5° to 25° and the larger offset angle β² varies between 30° to 40°. In the exemplary embodiments the offset angle β increases from the smaller offset angle β¹ of about 23° to the larger offset angle β² of about 35°. The curved profile and larger angle β² result in the internal obtuse angle α¹ at the corner between the leading face 34 and the tangential distal edge 38 being further enlarged, which is about 130° in the exemplary embodiment. This makes the corner between the leading face 34 and the tangential distal edge 38 less pronounced and thus the paddle 32 is less susceptible to wearing.

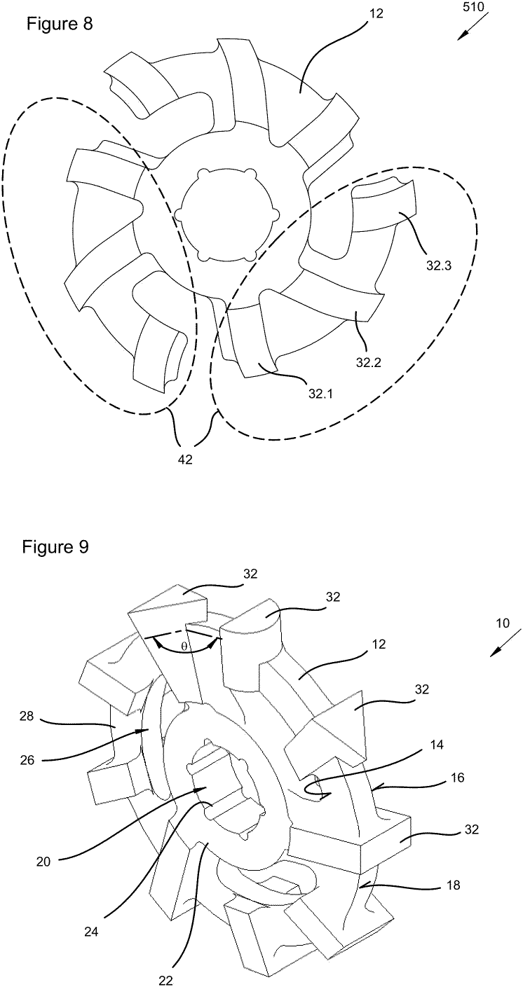

FIG. 8 shows a fifth embodiment of a grinding mill rotor 510 being similar to the fourth embodiment grinding mill rotor 410. The paddles 32 of the grinding mill rotor 510 are associated in three groups 44 of three paddles 32 each, wherein the rotationally following paddles 32 within each group 44 each have a distal edge 38 located radially further outwardly than that of its preceding paddle 32. This can be more clearly understood with reference to FIG. 8, wherein it can be seen that paddle 32.1 rotationally leads its group 44 and has the shortest length, while paddles 32.2 and 32.3 respectively extend further radially outwardly away from the collar 22. Having these different length paddles 32 improves consistency in the rate of wearing so that the respective paddles 32.1, 32.2 and 32.3 wear more evenly.

Within each group 44, the body 12 also enlarges spirally around the collar 22 so that the paddles 32 are adequately supported and that the distal edges 38 of the paddles 32.2 and 32.3 extend beyond the outer edge 18 of the body 12 by the same amount as does paddle 32.1.

It will be appreciated by persons skilled in the art that numerous variations and/or modifications may be made to the grinding mill rotor as shown in the specific embodiments without departing from the spirit or scope of the disclosure as broadly described. The present embodiments are, therefore, to be considered in all respects as illustrative and not restrictive.

In the claims which follow and in the preceding description, except where the context requires otherwise due to express language or necessary implication, the word “comprise” or variations such as “comprises” or “comprising” is used in a non-limiting and an inclusive sense, i.e. to specify the presence of the stated features but not to preclude the presence or addition of further features in the various embodiments of the crusher. A reference to an element by the indefinite article “a” does not exclude the possibility that more than one of the elements is present, unless the context clearly requires that there be one and only one of the elements.

Reference numerals

| | |
|---|---|
| 10 | grinding mill rotor (first embodiment) |
| 12 | body |
| 14 | surface |
| 16 | surface |
| 18 | outer edge |
| 20 | hole |
| 22 | collar |
| 24 | grooves |
| 26 | passages |
| 28 | ring |
| 30 | spokes |
| 32 | paddles |
| 32.1 | paddle |
| 32.2 | paddle |
| 32.3 | paddle |
| 34 | leading face |
| 36 | orthogonal line |
| 38 | distal edge |
| 40 | proximal edge |
| 41 | direction of rotation |
| 42 | slots |
| 44 | group |
| β | offset angle |
| β¹ | offset angle |
| β² | offset angle |
| α | internal angle |
| 210 | grinding mill rotor (second embodiment) |
| 310 | grinding mill rotor (third embodiment) |
| 410 | grinding mill rotor (fourth embodiment) |
| 510 | grinding mill rotor (fifth embodiment) |

1. A grinding mill rotor for a grinding mill, wherein the grinding mill rotor is configured to stir a slurry including particulate material and a grinding medium within the grinding mill thereby to cause turbulence within the slurry to promote attrition of the particulate material through interaction with the grinding medium, the grinding mill rotor comprising
a planar body having an axis of rotation around which the body is configured to rotate during use;
a plurality of paddles provided on the body and extending transversely across the body, the paddles being spaced apart from each other around the axis of rotation, at least some of the paddles having a rotationally leading face that is angled relative to an orthogonal line extending orthogonally from the axis of rotation of the body;
wherein an offset angle β between the leading face and the orthogonal line is selected to be between 1° and 35°, and wherein the offset angle β is selected to control a rate at which the slurry slides across the planar body during use.

2. A grinding mill rotor as claimed in claim 1, wherein the paddles are substantially block-like having a rectangular cross-section, a triangular cross-section, a V-shaped cross-section, or an arcuate segment shaped cross-section.

3. A grinding mill rotor as claimed in claim 1, wherein the body comprises opposed surfaces being substantially parallel to each other and wherein the paddles extend from at least one of the opposed surfaces.

4. A grinding mill rotor as claimed in claim 1, wherein the body comprises an outer radial edge and the paddles extend radially outwardly beyond the outer edge.

5. A grinding mill rotor as claimed in claim 1, further comprising a number of arcuate passages extending through the body, whereby an outer portion of the body forms a ring and an inner portion of the body forms spokes leading from the ring towards the axis of rotation.

6. A grinding mill rotor as claimed in claim 5, wherein at least one paddle extends across each of the spokes.

7. A grinding mill rotor as claimed in claim 5, comprising one or more slots extending through the outer portion of the body, wherein each slot leads into one of the passages.

8. A grinding mill rotor as claimed in claim 1, wherein a distal edge of the paddles is orientated tangential to the axis of rotation.

9. A grinding mill rotor as claimed in claim 1, wherein the offset angle β for each paddle is between 10° to 20°.

10. A grinding mill rotor as claimed in claim 1, wherein the offset angle β for each paddle is about 15°.

11. A grinding mill rotor as claimed in claim 1, wherein the offset angle β is selected to regulate a rate at which the planar body and the paddles experience frictional wear when the slurry is outwardly deflected or wherein the offset angle β is selected to regulate the grinding efficiency of the grinding mill.

12. A grinding mill rotor as claimed in claim 1, wherein each paddle has a curved profile, being curved radially away from or towards an operational direction of rotation of the body, whereby the offset angle β varies along the length of the paddle with a smaller offset angle β¹ nearer to the axis of rotation and with a larger offset angle p² further away from the axis of rotation.

13. A grinding mill rotor as claimed in claim 12, wherein the smaller offset angle 131 is between 5° to 25° and the larger offset angle β² is between 30° to 40°.

14. A grinding mill rotor as claimed in claim 1, wherein the paddles are associated into groups within which each paddle that rotationally follows another extends further outwardly than its preceding paddle.

15. A grinding mill rotor as claimed in claim 14, wherein the body enlarges spirally so that all the paddles overhang the body to a similar extent.

16. A grinding mill rotor as claimed in claim 1, wherein the paddles are integrally formed with the body.

17. A grinding mill rotor as claimed in claim 1, wherein the paddles comprise rubber polymer or polyurethane structures that are bonded to the body.

18. A grinding mill comprising a grinding mill rotor as claimed in claim 1.

19. Use of the grinding mill rotor as claimed in claim 1 in a grinding mill.
